(19) United States
(12) Patent Application Publication
(10) Pub. No.: US 2023/0006850 A1
(43) Pub. Date: Jan. 5, 2023

(54) AUTOMATIC REPAIR OF WEB CONFERENCE SESSION RECORDING

(71) Applicant: CITRIX SYSTEMS, INC., Fort Lauderdale, FL (US)

(72) Inventors: Lei Liu, Nanjing (CN); Xiao Yuan, Nanjing (CN)

(21) Appl. No.: 17/393,042

(22) Filed: Aug. 3, 2021

Related U.S. Application Data
(63) Continuation of application No. PCT/CN2021/103441, filed on Jun. 30, 2021.

(51) Int. Cl. H04L 12/18; H04L 29/06

(52) U.S. Cl. CPC H04L 12/1831; H04L 12/1827; H04L 65/80; H04N 7/155

(57) ABSTRACT

A method for repairing a recording of a web conference session may include generating, at a first client device, a first recording of the web conference session with a second client device. The quality of the data received from the second client device may be monitored. In response to the quality of the data being below a threshold level, a first command to start a second recording of the web conference session at the second client device may be sent to the second client device. The first recording of the web conference session may be sent to a repair engine to enable the repair engine to generate a third recording of the web conference session in which a first portion of the first recording is replaced and/or combined with at least a second portion of the second recording. Related systems and articles of manufacture are also provided.

### TECHNICAL FIELD

The subject matter described herein relates generally to web conferencing and more specifically to the repairing a recording of a web conference session.

### BACKGROUND

A web conferencing application may provide access to a virtual meeting room in which multiple users in different locations may engage in real time audio data and/or video communication. The web conferencing application may support a variety of online communication sessions between two or more web-connected devices including, for example, meetings, training events, lectures, presentations, and/or the like. In some cases, the web conferencing application may also provide various collaborative features such as real time content sharing and editing.

### SUMMARY

Methods, systems, and articles of manufacture, including computer program products, are provided for repairing a recording of a web conference session. In one aspect, there is provided a system including at least one data processor and at least one memory. The at least one memory may store instructions, which when executed by the at least one data processor, cause the at least one data processor to at least: generate, at a first client device, a first recording of a web conference session between the first client device and a second client device; monitor a quality of a data received from the second client device; in response to the quality of the data being below a threshold level, send, to the second client device, a first command to start a second recording of the web conference session at the second client device; and send, to a repair engine, the first recording of the web conference session to enable the repair engine to generate a third recording of the web conference session in which a first portion of the first recording is replaced and/or combined with at least a second portion of the second recording.

In some variations, one or more of the features disclosed herein including the following features can optionally be included in any feasible combination. The quality of the data may be monitored by at least monitoring a quality of a network connection between the first client device and the second client device.

In some variations, the quality of the network connection may be monitored by at least measuring a latency, a jitter, and/or a packet loss.

In some variations, the quality of the data may be monitored by at least measuring a signal to noise ratio (SNR) and/or a bit error ratio (BER).

In some variations, the at least one data processor may be further caused to at least: in response to the quality of the data exceeding the threshold level, send, to the second client device, a second command to stop the second recording of the web conference session at the second client device.

In some variations, the first command and/or the second command may be further sent in response to one or more user inputs received at the first client device.

In some variations, the at least one data processor may be further caused to at least: generate context data associated with the second recording of the web conference session; and send, to the repair engine, the context data to enable the repair engine to generate, based at least on the context data, the third recording of the web conference session.

In some variations, the context data may include a starting timestamp and/or an ending timestamp of the second recording.

In some variations, the first portion of the first recording may be replaced with the second portion of the second recording based at least on a first quality of the first portion of the first recording being below threshold and/or less than a second quality of the second portion of the second recording.

In some variations, the data may include an audio data and/or a video data.

In another aspect, there is provided a method for repairing a recording of a web conference session. The method may include: generating, at a first client device, a first recording of a web conference session between the first client device and a second client device; monitoring a quality of a data received from the second client device; in response to the quality of the data being below a threshold level, sending, to the second client device, a first command to start a second recording of the web conference session at the second client device; and sending, to a repair engine, the first recording of the web conference session to enable the repair engine to generate a third recording of the web conference session in which a first portion of the first recording is replaced and/or combined with at least a second portion of the second recording.

In some variations, one or more of the features disclosed herein including the following features can optionally be included in any feasible combination. The quality of the data may be monitored by at least monitoring a quality of a network connection between the first client device and the second client device.

In some variations, the quality of the network connection may be monitored by at least measuring a latency, a jitter, and/or a packet loss.

In some variations, the quality of the data may be monitored by at least measuring a signal to noise ratio (SNR) and/or a bit error ratio (BER).

In some variations, the method may further include: in response to the quality of the data exceeding the threshold level, sending, to the second client device, a second command to stop the second recording of the web conference session at the second client device.

In some variations, the first command and/or the second command may be further sent in response to one or more user inputs received at the first client device.

In some variations, the method may further include: generating context data associated with the second recording of the web conference session; and sending, to the repair engine, the context data to enable the repair engine to generate, based at least on the context data, the third recording of the web conference session.

In some variations, the context data may include a starting timestamp and/or an ending timestamp of the second recording.

In some variations, the first portion of the first recording may be replaced with the second portion of the second recording based at least on a first quality of the first portion of the first recording being below threshold and/or less than a second quality of the second portion of the second recording.

In another aspect, there is provided a computer program product that includes a non-transitory computer readable medium. The non-transitory computer readable medium may store instructions that cause operations when executed by at least one data processor. The operations may include: generating, at a first client device, a first recording of a web conference session between the first client device and a second client device; monitoring a quality of a data received from the second client device; in response to the quality of the data being below a threshold level, sending, to the second client device, a first command to start a second recording of the web conference session at the second client device; and sending, to a repair engine, the first recording of the web conference session to enable the repair engine to generate a third recording of the web conference session in which a first portion of the first recording is replaced and/or combined with at least a second portion of the second recording.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to repairing audio data from a web conference session, it should be readily understood that such features are not intended to be limiting. The claims that follow this disclosure are intended to define the scope of the protected subject matter.

### DESCRIPTION OF DRAWINGS

FIG. 1A depicts a system diagram illustrating an example of a web conferencing system, in accordance with some example embodiments;

FIG. 1B depicts a block diagram illustrating an example of the architecture of a web conferencing system, in accordance with some example embodiments;

FIG. 2A depicts a schematic diagram illustrating an example of a process for monitoring network quality, in accordance with some example embodiments;

FIG. 2B depicts a schematic diagram illustrating an example of a process for repairing a recording of a web conference session, in accordance with some example embodiments;

FIG. 3A depicts a schematic diagram illustrating an example of a technique for repairing a recording of a web conference session, in accordance with some example embodiments;

FIG. 3B depicts a schematic diagram illustrating another example of a technique for repairing a recording of a web conference session, in accordance with some example embodiments;

FIG. 3C depicts a schematic diagram illustrating another example of a technique for repairing a recording of a web conference session, in accordance with some example embodiments;

FIG. 4A depicts a sequence diagram illustrating an example of a process for repairing a recording of a web conference session, in accordance with some example embodiments;

FIG. 4B depicts a flowchart illustrating another example of a process for repairing a recording of a web conference session, in accordance with some example embodiments;

FIG. 4C depicts a flowchart illustrating another example of a process for repairing a recording of a web conference session, in accordance with some example embodiments;

FIG. 5A depicts a network diagram illustrating an example of a network environment, in accordance with some example embodiments;

FIG. 5B depicts a block diagram illustrating an example of a computing device, in accordance with some example embodiments; and

FIG. 5C depicts a high-level architecture of an example of a virtualization system for implementing a computing system, in accordance with some example embodiments.

When practical, like reference symbols in the various drawings indicate like elements.

### DETAILED DESCRIPTION

A web conferencing application, which provides access to a virtual meeting room in which multiple users in different locations may engage in real time audio data and/or video communication, may further support the recording of the audio data and/or video communication. For example, a web conference session may include a host who schedules the web conference session and one or more attendees who join the web conference session. The host of the web conference session may interact with the web conferencing application to start and end the web conference session. Moreover, the host of the web conference session may interact with the web conferencing application to record the web conference session. The recording of the web conference session may include audio data and/or video data originating from the host and/or the attendees.

In a typical scenario, the recording of the web conference session may be captured at a first device associated with the host. As such, the recording of the web conference session may include a first segment of audio data and/or video data generated locally at the first device, for example, when the host is the presenter contributing audio content and/or video content. Moreover, the recording of the web conference session may include a second segment of audio data and/or video data generated remotely at a second device of a attendee when that attendee is the presenter contributing audio content and/or video content. The second segment of audio data and/or video data may be sent to the first device via a network connection such that the second segment of audio data and/or video data may be captured as part of the recording of the web conference session.

The quality of the recording of the web conference session, when captured entirely at the first device, may be inconsistent at least because the quality of the second segment received at the first device may be poor. A variety of factors may diminish the quality of the second segment of audio data and/or video data received at the first device including, for example, a degradation in the network connection between the first device and the second device. As such, in some example embodiments, at least a portion of the web conference session may be recorded at the second device of the attendee to supplement the recording of the web conference session captured at the first device of the host. When the second segment of audio data and/or video data received at the first device exhibits a below threshold quality, for example, due to a degradation of the network connection between the first device and the second device, the recording of the web conference session may include a first recording of the second segment captured at the second device instead of a second recording of the second segment captured at the first device. The resulting recording, which synthesizes recordings captured at the first device and the second device, may exhibit a more consistent quality than a conventional recording captured entirely at the first device.

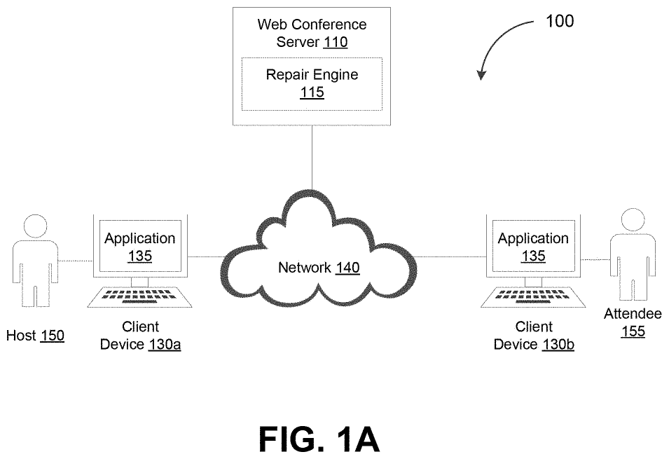

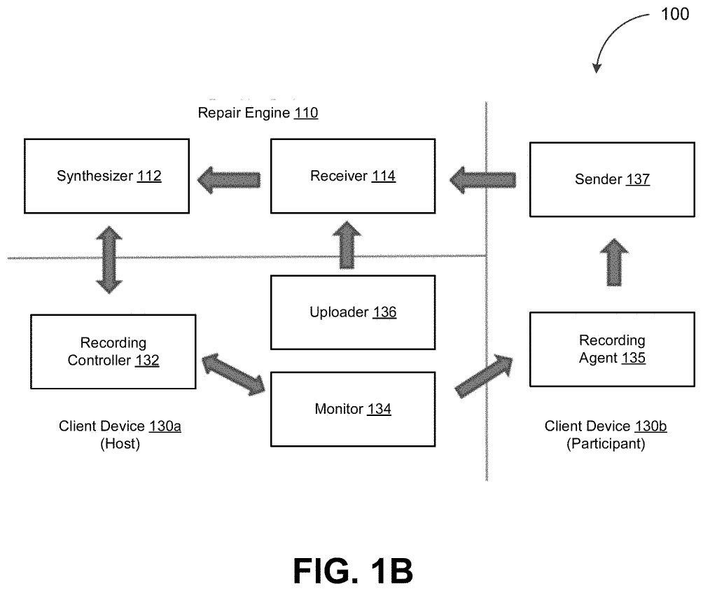

FIG. 1A depicts a system diagram illustrating an example of a web conferencing system 100, in accordance with some example embodiments. Referring to FIG. 1A, the web conferencing system 100 may include a web conference server 110 including a repair engine 115 that is communicatively coupled via a network 140 with one or more client devices 130 including, for example, a first client device 130a, a second client device 130b, and/or the like. The one or more client devices 130 may be processor-based devices including, for example, a smartphone, a personal computer, a tablet computer, a wearable apparatus, an Internet-of-Things (IoT) appliance, and/or the like. The network 140 may be a wired network and/or a wireless network including, for example, a local area network (LAN), a virtual local area network (VLAN), a wide area network (WAN), a public land mobile network (PLMN), the Internet, and/or the like.

A web conferencing application 135 at each of the one or more client devices 130 may be configured to provide access to a virtual meeting room in which a host 150 at the first client device 130a and one or more attendees such as the attendee 155 at the second client device 130b may engage in real time audio data and/or video communication. Moreover, the web conferencing application 135 may support a recording functionality in which a recording is generated of the web conference session between the host 150 at the first client device 130a and the attendee 155 at the second client device 130b. For example, a recording of the web conference session may be generated in response to the web conferencing application 135 receiving, from the host 150 at the first client device 130a, a request to record the web conference session.

The recording of the web conference session may include a first segment of audio data and/or video data generated at the first client device 130a, for example, when the host 150 is the presenter contributing audio content and/or video content. Moreover, the recording of the web conference session may include a second segment of audio data and/or video data generated at the second device 130b when the attendee 155 is the presenter contributing audio content and/or video content. Conventionally, the recording of the web conference session may be captured entirely at the first client device 130a of the host 150 with the second segment of audio data and/or video data being sent from the second client device 130b to the first client device 130a via the network 140. However, the quality of the recording of the web conference session captured in this manner may be inconsistent at least because the quality of the second segment of audio data and/or video data received at the first client device 130a may be degraded when the network connection between the first client device 130a and the second client device 130b is poor.

In some example embodiments, at least a portion of the web conference session may be recorded at the second client device 130b to supplement the recording of the web conference session captured at the first device 130a. Thus, when the second segment of audio data and/or video data received at the first client device 130a exhibits a below threshold quality, for example, due to a degradation of the network connection between the first client device 130a and the second client device 130b, the recording of the web conference session may include a first recording of the second segment captured at the second client device 130b instead of a second recording of the second segment captured at the first client device 130a.

The repair engine 115 may repair the recording of the web conference session by at least replacing the second recording of the second segment captured at the first client device 130a with the first recording of the second segment captured at the second client device 130b. Moreover, the repair engine 115 may combine the first recording of the second segment captured at the second client device 130b with a third recording of the first segment captured at the first client device 130a to generate the recording of the web conference session. The resulting recording, which synthesizes recordings captured at the first client device 130a and the second client device 130b, may exhibit a more consistent quality than a conventional recording captured entirely at the first client device 130a.

FIG. 1B depicts a block diagram illustrating an example of the architecture of the web conferencing system 100, in accordance with some example embodiments. As shown in FIG. 1B, the repair engine 115 may include a synthesizer 112 and a receiver 114. Moreover as shown in FIG. 1B, the first client device 130a, which is associated with the host 150 of the web conference session being recorded, may include a recording controller 132, a monitor 134, and an uploader 136. The second client device 130b, which is associated with the attendee 155 of the web conference session being recorded, may include a recording agent 135 and a sender 137.

The recording controller 132 may be configured to coordinate the recording of the web conference session between the host 150 at the first client device 130a and the attendee 155 at the second client device 130b. As noted, in order to maintain consistency in the quality of the recording, at least the first segment of the web conference session may be recorded at the second client device 130b and combined with the second segment of the web conference session recorded at the first client device 130a. In the example of the web conferencing system 100 shown in FIG. 1B, the first segment of the web conference session may be recorded at the second client device 130b when the audio data and/or video data received at the first client device 130a from the second client device 130b exhibits a below-threshold quality or when the network connection between the first client device 130a and the second device 130b exhibits a below-threshold quality.

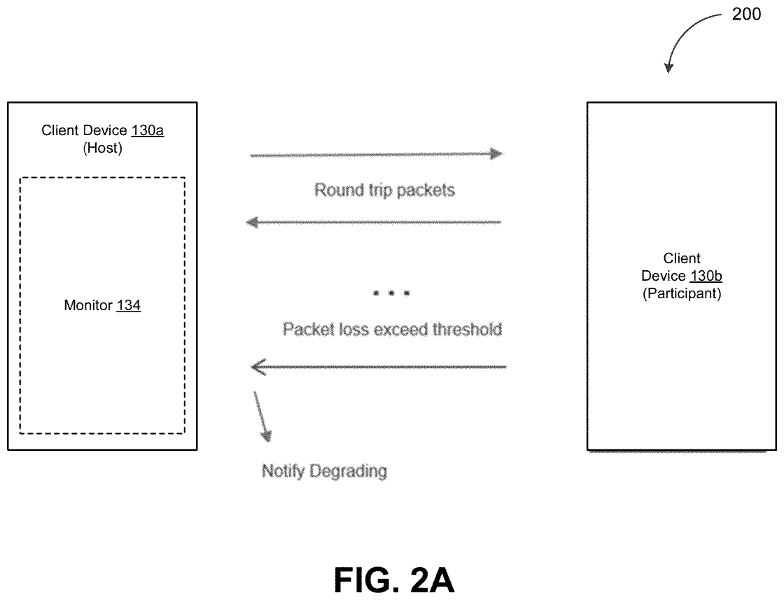

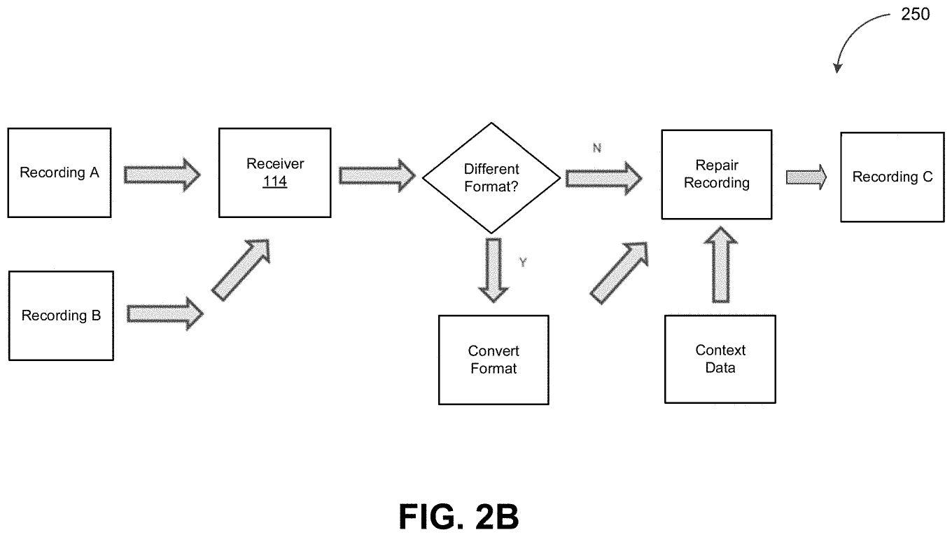

Accordingly, as shown in FIG. 1B, the monitor 134 at the first client device 130a may be configured to monitor the quality of the data received from the second client device 130b including, for example, the quality of the audio data, video data, and/or the like. For example, the monitor 134 may monitor the quality of the data received at the first client device 130a by at least measuring a signal to noise ratio (SNR), a bit error ratio (BER), and/or the like. Alternatively and/or additionally, the monitor 134 may monitor the quality of the network connection between the first client device 130a and the second client device 130b. The monitor 134 may monitor the quality of the network connection by measuring a latency, a jitter, a packet loss, and/or the like. FIG. 2A depicts a schematic diagram illustrating an example of a process 200 for monitoring network quality, in accordance with some example embodiments. In the example shown in FIG. 2A, the monitor 134 may notify the recording controller 132 of a below-threshold quality network connection between the first client device 130a and the second client device 130b when the monitor 134 determines that the first client device 130a fails to receive more than a threshold quantity of data packets from the second client device 130b.

In some example embodiments, the recording controller 132 may be configure to trigger, based at least on the quality of the data received from the second client device 130b and/or the quality of the network connection between the first client device 130a and the second device 130b, a recording of the web conference session at the second client device 130b. For example, the recording controller 132 may send, to the recording agent 135 at the second client device 130b, a first command to start the recording of the web conference session when the quality of the data received from the second client device 130b and/or the quality of the network connection between the first client device 130a and the second device 130b is below a threshold level. Alternatively and/or additionally, the recording controller 132 may send, to the recording agent 135 at the second client device 130b, a second command to stop the recording of the web conference session when the quality of the data received from the second client device 130b and/or the quality of the network connection between the first client device 130a and the second device 130b exceeds the threshold level.

The recording controller 132 may also send, to the second client device 130b, the command to start and/or stop the recording of the web conference session in response to one or more corresponding inputs received at the first client device 130a. For example, the first client device 130a may receive, from the host 150, a first input indicating that the quality of audio data and/or video data received from the second client device 130b is below a threshold level. The recording controller 132 may respond to the first input by sending, to the recording agent 135 at the second client device 130b, the first command to start the recording of the web conference session. Alternatively, the first client device 130a may receive, from the host 150, a second input indicating that the quality of audio data and/or video data received from the second client device 130b is above a threshold level. The recording controller 132 may respond to the second input by sending, to the recording agent 135 at the second client device 130b, the second command to start the recording of the web conference session.

In some example embodiments, the recording controller 132 may generate context data associated with the recording performed at the second client device 130b including, for example, a starting timestamp and/or an ending timestamp for the first segment of the web conference session recorded at the second client device 130b. It should be appreciated that in some cases, instead of and/or in addition to the recording controller 132 generating the context data, at least a portion of the context data may be generated by the recording agent 135 at the second client device 130b. For example, in some cases, the recording controller 132 may generate the starting timestamp upon triggering the recording of the web conference session at the second client device 130b whereas the recording agent 135 may generate the ending timestamp upon stopping the recording of the web conference session at the second client device 130b.

The sender 137 at the second client device 130b may send, to the receiver 114 at the repair engine 115, the first segment of the web conference session recorded at the second client device 130b. The sender 137 may package, encrypt, and/or compress the first segment of the web conference session before sending the first segment of the web conference session to the repair engine 115. Meanwhile, the uploader 136 at the first client device 130a may send, to the receiver 114 at the repair engine 115, the second segment of the web conference session recorded at the first client device 130a. The second segment of the web conference session may also be packaged, encrypted, and/or compressed before being sent to the repair engine 115. As shown in FIG. 1B, the synthesizer 112 may be configured to repair the recording of the web conference session by at least combining the first segment of the web conference session recorded at the second client device 130b with the second segment of the web conference session recorded at the first client device 130a. In some cases, the repair may further include replacing the first segment of the web conference session recorded at the first client device 130a, which may exhibit a below-threshold quality, with the first segment of the web conference session recorded at the second client device 130b.

To further illustrate, FIG. 2B depicts a schematic diagram illustrating an example of a process 250 for repairing a recording of a web conference session. As shown in FIG. 2B, the process 250 may include the receiver 114 at the repair engine 115 receiving Recording A from the first client device 130a and Recording B from the second client device 130b. Moreover, FIG. 2B shows that prior to repairing the recording of the web conference session, for example, the repair engine 115 may reconcile the format of Recording A and Recording B such that Recording A and Recording B are in a same format. For example, the repair engine 115 may convert Recording A from a first format to a second format of Recording B. Alternatively and/or additionally, the repair engine 115 may convert Recording A from the first format to a third format and Recording B from the second format to the third format.

In some example embodiments, the repair engine 115 may repair the recording of the web conference session by synthesizing, based at least on context data associated with Recording A and Recording B, Recording A and Recording B. For example, the timestamps associated with a start and/or an end of Recording A and Recording B may enable the repair engine 115 to identify and align the time periods covered by each recording (or portions thereof). It should be appreciated that Recording A from the first client device 130a and Recording B from the second client device 130b may each contain at least a portion of the entire web conference session. The synthesis may include replacing and/or combining at least a first portion of Recording A with at least a second portion of Recording B. The resulting Recording C may include the web conference session in its entirety. Because the replacing and/or combining may be performed based at least on a respective quality of Recording A and Recording B, the resulting Recording C may exhibit a more consistent quality than a recording that is captured entirely at the first client device 130a or the second client device 130b.

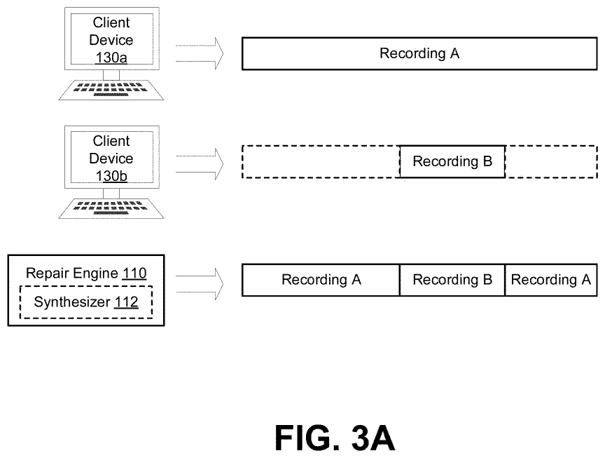

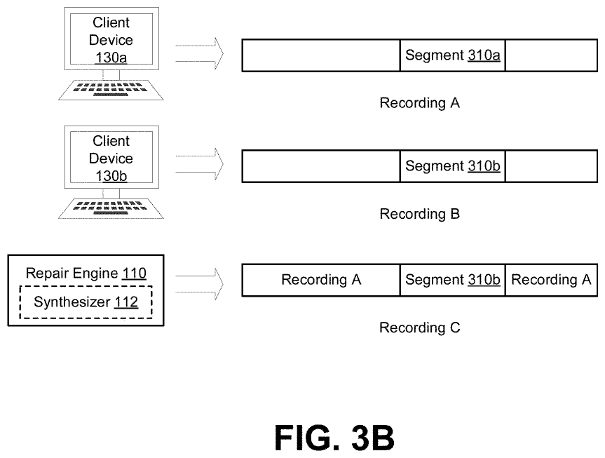

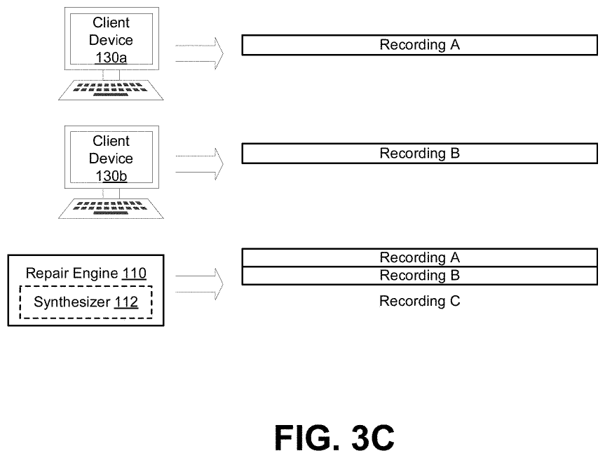

FIGS. 3A-C depict schematic diagrams illustrating various examples of techniques for repairing a recording of a web conference session, in accordance with some example embodiments. It should be appreciated that the repair engine 115 may apply any technique (or combination of techniques) to synthesize Recording A from the first client device 130a and Recording B from the second client device 130b to generate Recording C of the web conference session.

For example, in FIG. 3A, Recording A from the first client device 130a may include audio data and/or video data for the entire web conference session while Recording B from the second client device 130b may include a portion of the audio data and/or video data from the web conference session. As noted, in some example embodiments, the recording agent 135 at the second client device 130b may record the web conference session while the network connection between the first client device 130a and the second client device 130b is below a threshold quality and/or when the audio data and/or video data received at the first client device 130a from the second client device 130b is below a threshold quality. In the example of the synthesis technique shown in FIG. 3A, the repair engine 115 may replace a portion of Recording A with Recording B in order to generate Recording C.

FIG. 3B depicts another example of a technique to synthesize Recording A and Recording B in which Recording A and Recording B each include the entire web conference session. In this example, the repair engine 115 may analyze Recording A and Recording B to identify one or more segments where the quality of the data (e.g., audio data, video data, and/or the like) in one recording is below a threshold level and/or inferior to the quality of the other recording. Thus, in the example shown in FIG. 3B, the repair engine 115 may determine that the quality of a first segment 310a of Recording A is below a threshold level and/or inferior to the quality of a corresponding second segment 310b of Recording B. Accordingly, the repair engine 115 may replace the first segment 310a of Recording A with the second segment 310b of Recording B in order to generate Recording C.

FIG. 3C depicts yet another example of a technique to synthesize Recording A and Recording B. In the example shown in FIG. 3C, the first client device 130a may capture audio data and/or video data originating from the host 150 at the first client device 130a but not audio data and/or video data originating from the attendee 155 and sent to the first client device 130a via the network 140. For example, Recording A may include audio data captured by a microphone (or other audio sensors) at the first client device 130a. Similarly, the second client device 130b may capture audio data and video data originating from the attendee 155 at the second client device 130b, such as audio data captured by a microphone (or other audio sensors) at the second client device 130b, but not audio data and/or video data originating from the host 150 at the first client device 130a and sent to the second client device 130b via the network 140. To generate Recording C, the repair engine 115 may combine Recording A, which includes the audio data and/or video data associated with the host 150, and Recording B, which includes the audio data and/or video associated with the attendee 155.

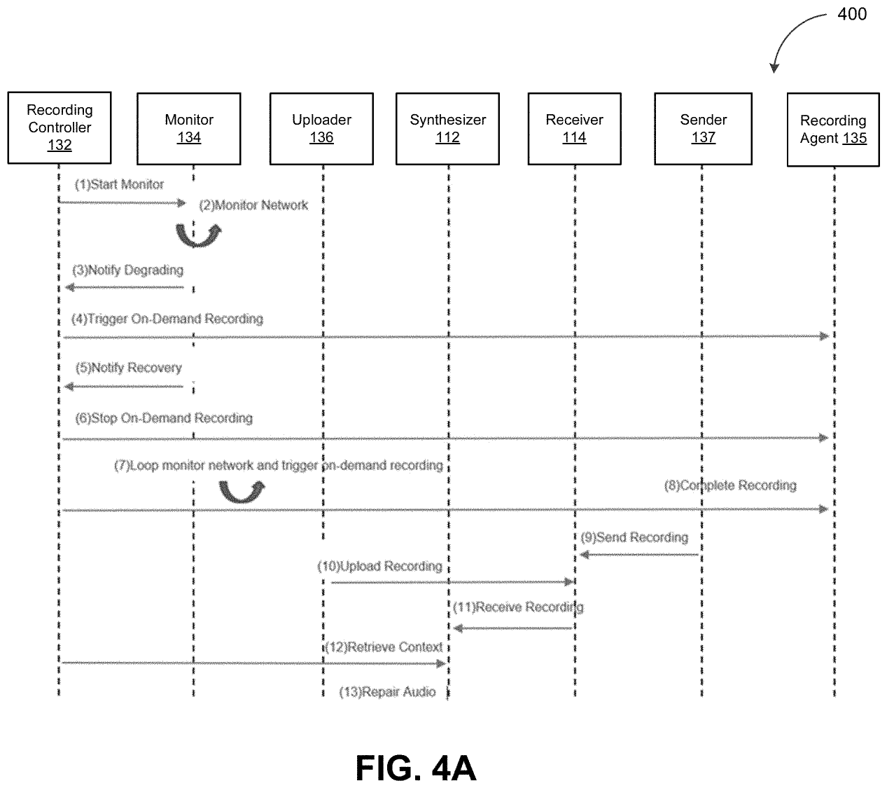

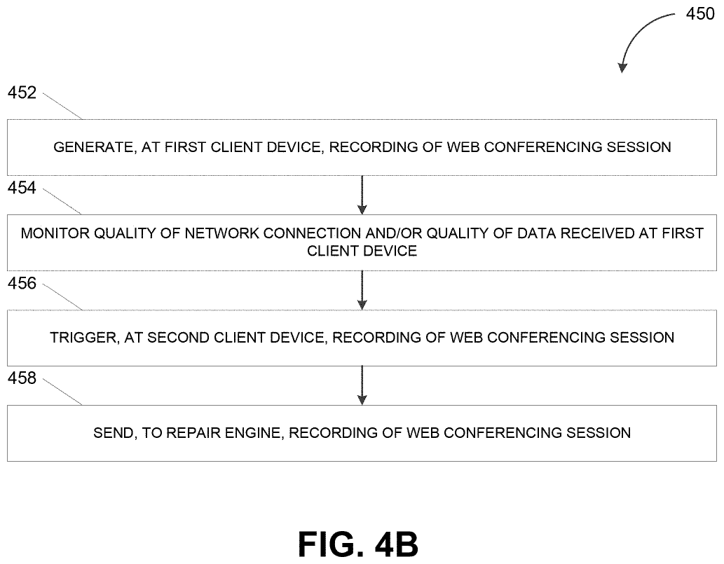

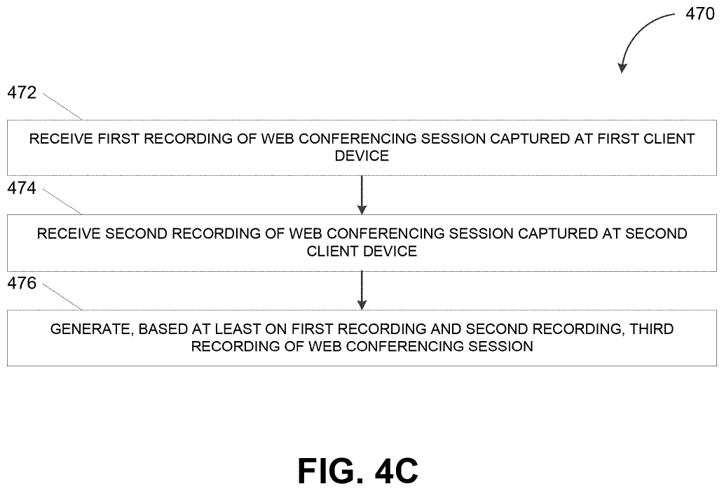

FIG. 4A depicts a sequence diagram illustrating an example of a process 400 for repairing a recording of a web conference session, in accordance with some example embodiments. At (1) the recording controller 132 at the first client device 130a may start the monitoring of the quality of the network connection between the first client device 130a and the second client device 130b and/or the quality of the data received at the first client device 130a from the second client device 130b. For example, as shown in FIG. 4A, the recording controller 132 may start the monitoring by sending, to the monitor 134, a command to start the monitoring. At (2), the monitor 134 may respond to the command by monitoring the quality of the network connection between the first client device 130a and the second client device 130b and/or the quality of the data received at the first client device 130a from the second client device 130b. At (3), upon detecting a degradation in the quality of the network connection and/or the quality of the data, the monitor 134 may send, to the recording controller 132, a corresponding notification. At (4), the recording controller 132 may respond to the notification from the monitor 134 by sending, to the recording agent 135 at the second client device 130b, a command to start recording the web conference session at the second client device 130b.

At (5), the monitor 134 may send, upon detecting a recovery in the quality of the network connection and/or the quality of the data, a corresponding notification to the recording controller 132. In response to receiving the notification from the monitor 134, the recording controller 132 may, at (6), send a command for the recording agent 135 to stop the recording of the web conference session at the second client device 130b. It should be appreciated that at (7), the monitor 134 may continue to monitor the quality of the network connection and/or the quality of the data received from the second client device 130b. Moreover, at (7), the recording controller 132 may continue to control the recording of the web conference session at the second client device 130b based on notifications from the monitor 134.

The recording of the web conference session may be completed at (8), for example, when the host 150 sends, to the web conferencing application 135 at the first client 130a, an indication to end the web conference session. At (9), the sender 137 at the second client device 130b may send, to the receiver 114 at the repair engine 115, the recording(s) of the web conference session captured at the second client device 130b. Meanwhile, at (10), the uploader 136 at the first client device 130a may send, to the receiver 114 at the repair engine 115, the recording(s) of the web conference session captured at the first client device 130a.

At (11), the synthesizer 112 at the repair engine 115 may receive, from the receiver 114, the recording(s) captured at each of the first client device 130a and the second client device 130b. Moreover, at (12), the synthesizer 112 may receiver, from the recording controller 132, context data associated with the recording(s) captured at the first client device 130a and/or the second client device 130b. This context data may include, for example, a starting timestamp and/or an ending timestamp for the segments of the web conference session recorded at the first client device 130a and/or the second client device 130b. At (13), the synthesizer 112 may repair the recording of the web conference session, for example, by replacing and/or combining at least a first portion of a recording captured at the first client device 130a with at least a second portion of a recording captured at the second client device 130b.

FIG. 4B depicts a flowchart illustrating an example of a process 450 for repairing a recording of a web conference session, in accordance with some example embodiments. Referring to FIGS. 1A-B, 2-B, 3A-C, and 4B, the process 450 may be performed at the first client device 130a in order to generate a recording of a web conference session between the host 150 at the first client device 130a and the attendee 155 at the second client device 130b.

FIG. 4B depicts a flowchart illustrating an example of a process 450 for repairing a recording of a web conference session, in accordance with some example embodiments. Referring to FIGS. 1A-B, 2-B, 3A-C, and 4B, the process 450 may be performed at the first client device 130a in order to generate a recording of a web conference session between the host 150 at the first client device 130a and the attendee 155 at the second client device 130b.

At 452, the first client device 130a may record a web conference session. For example, the first client device 130a may be associated with the host 150 of the web conference session. As such, a recording of the web conference session may be generated in response to the web conferencing application 135 receiving, from the host 150 at the first client device 130a, a request to record the web conference session.

At 454, the first client device 130a may monitor a quality of a network connection and/or a quality of data received at the first client device 130a. In some example embodiments, the monitor 134 at the first client device 130a may monitor the quality of the network connection between the first client device 130a and the second client device 130b including, for example, by measuring a latency, a jitter, a packet loss, and/or the like. Alternatively and/or additionally, the monitor 134 may monitor the quality of the data, such as audio data, video data, and/or the like, received at the first client device 130a from the second client device 130b. The monitor 134 may monitor the quality of the data received at the first client device 130a by at least measuring a signal to noise ratio (SNR), a bit error ratio (BER), and/or the like.

At 456, the first client device 130a may trigger a recording at the second client device 130b. In some example embodiments, the monitor 134 may send, to the recording controller 132, a notification when the quality of the network connection and/or the quality of the data received at the first client device 130a falls below a threshold level. The recording controller 132 may respond to the notification by at least sending, to the recording agent 135 at the second client device 130b, a command to start recording the web conference session at the second client device 130b. The monitor 134 may also detect an improvement in the quality of the network connection and/or the quality of the data received at the first client device 130a. When the quality of the quality of the network connection and/or the quality of the data received at the first client device 130a exceeds a threshold level, the monitor 134 may send a corresponding notification to the recording controller 132, which may respond by sending a command for the recording agent 135 to stop recording the web conference session at the second client device 130b.

At 458, the first client device 130a may send, to the repair engine 115, a recording of at least a portion of web conference session. The first client device 130a may send, to the repair engine 115, a first recording of the web conference session captured at the first client device 130a. The quality of the first recording may be inconsistent at least because of degradation in the quality of the network connection and/or the quality of the data received from the second client device 130b. As such, in some example embodiments, to repair engine 115 may replace and/or combine at least a first portion of the first recording captured at the first client device 130a with at least a second portion of a second recording captured at the second client device 130b. The resulting recording of the web conference session may include recordings captured at the first client device 130a and the second client device 130b, and may exhibit a more consistent quality than a recording captured entirely at either the first client device 130a or the second client device 130b.

FIG. 4C depicts a flowchart illustrating another example of a process 470 for repairing a recording of a web conference session, in accordance with some example embodiments. Referring to FIGS. 1A-B, 2-B, 3A-C, and 4C, the process 470 may be performed at the repair engine 115 in order to generate a recording of a web conference session between the host 150 at the first client device 130a and the attendee 155 at the second client device 130b.

At 472, the repair controller 132 may receive a first recording of a web conference session captured at the first client device 130a. For example, as shown in FIG. 2B, the first client device 130a may capture Recording A, which may include at least a first portion of the audio data and/or video data associated with the web conference session between the first client device 130a and the second client device 130b.

At 474, the repair controller 132 may receive a second recording of the web conference session captured at the first client device 130a. Referring again to the example shown in FIG. 2B, the second client device 130b may capture Recording B, which may include at least a first portion of the audio data and/or video data associated with the web conference session between the first client device 130a and the second client device 130b.

At 476, the repair controller 132 may generate, based at least on the first recording and the second recording, a third recording of the web conference session. For example, the receiver 114 at the repair controller 132 may receive Recording A from the uploader 136 at the first client device 130a and Recording B from the sender 137 at the second client device 130b respectively. FIGS. 3A-C depicts various examples of synthesis techniques that the synthesizer 112 at the repair engine 115 may apply to generate Recording C. In the example shown in FIG. 3A, the repair engine 115 may replace a portion of Recording A with Recording B in order to generate Recording C.

Alternatively, Recording A and Recording B may each include the entire web conference session, in which case the repair engine 115 may analyze Recording A and Recording B to identify one or more segments where the quality of the data (e.g., audio data, video data, and/or the like) in one recording is below a threshold level and/or inferior to the quality of the other recording. With this synthesis technique, which is shown in FIG. 3B, the repair engine 115 may replace the first segment 310a of Recording A with the second segment 310b of Recording B if the repair engine 115 determines that the quality of the first segment 310a of Recording A is below a threshold level and/or inferior to the quality of the corresponding second segment 310b of Recording B.

In FIG. 3C, Recording A and Recording B may each include data originating at one client device but not the other. For example, Recording A may include audio data captured by a microphone (or other audio sensors) at the first client device 130a while Recording B may include audio data captured by a microphone (or other audio sensors) at the second client device 130b. To generate Recording C, the repair engine 115 may combine Recording A, which includes the audio data and/or video data associated with the host 150, and Recording B, which includes the audio data and/or video associated with the attendee 155.

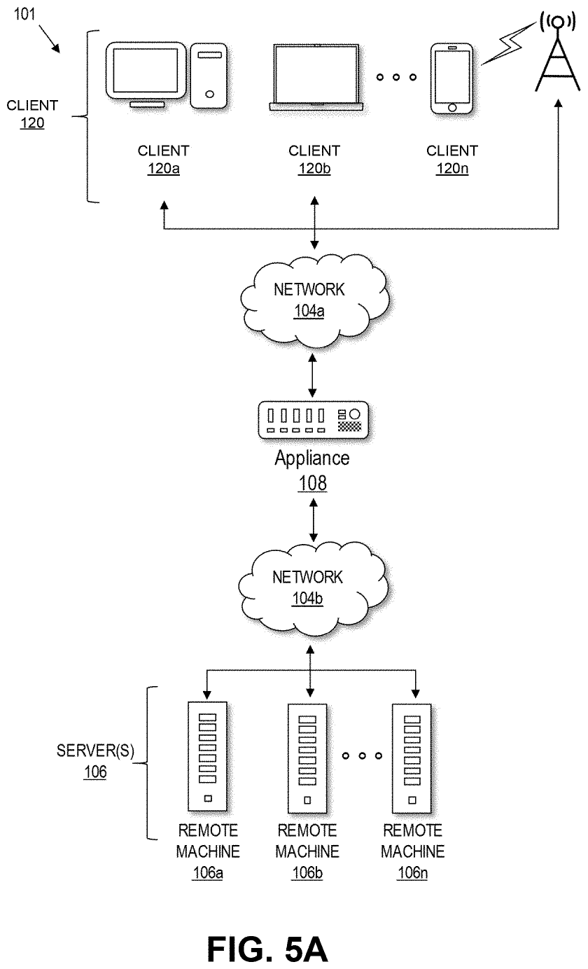

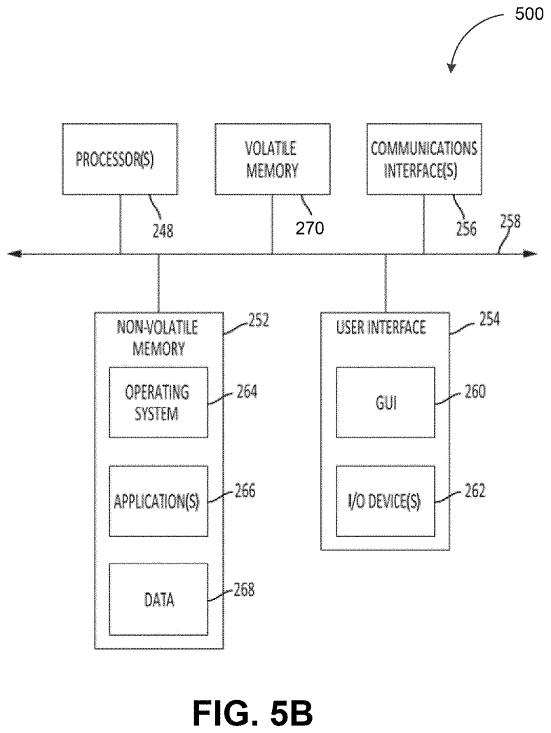

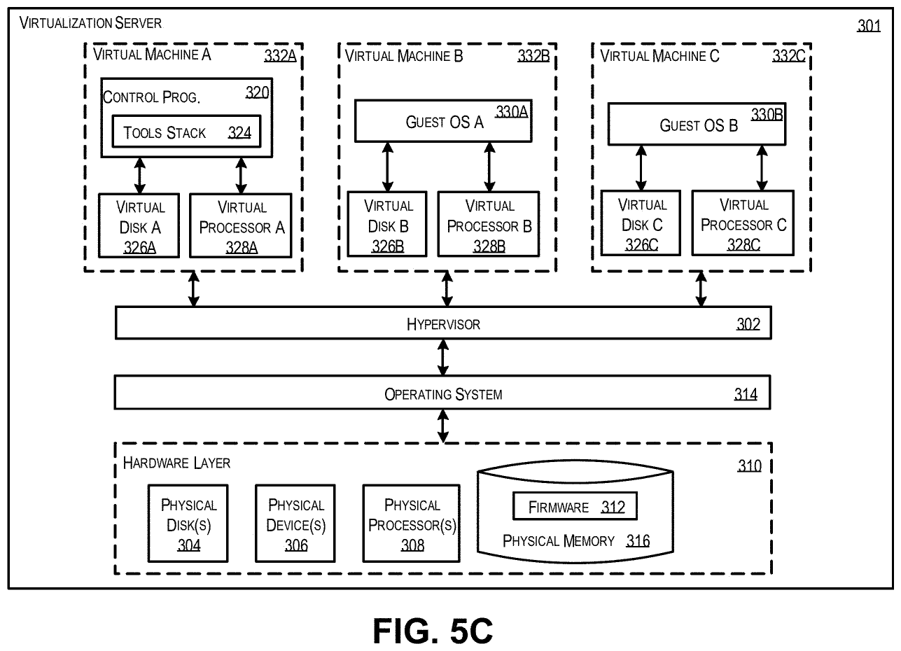

FIG. 5A depicts a network diagram illustrating an example of a network environment 101, in accordance with some example embodiments. Referring to FIGS. 1-4 and 5A, the network environment 101 in which various aspects of the disclosure may be implemented may include one or more clients 120a-120n, one or more remote machines 106a-106n, one or more networks 104a and 104b, and one or more appliances 108 installed within the network environment 101. The clients 120a-120n communicate with the remote machines 106a-106n via the networks 104a and 104b.

In some example embodiments, the clients 120a-120n may communicate with the remote machines 106a-106n via an appliance 108. The illustrated appliance 108 is positioned between the networks 104a and 104b, and may also be referred to as a network interface or gateway. In some example embodiments, the appliance 108 may operate as an application delivery controller (ADC) to provide clients with access to business applications and other data deployed in a datacenter, the cloud, or delivered as Software as a Service (SaaS) across a range of client devices, and/or provide other functionality such as load balancing and/or the like. In some example embodiments, multiple appliances 108 may be used, and the appliance(s) 108 may be deployed as part of the network 104a and/or 104b.

The clients 120a-120n may be generally referred to as client machines, local machines, clients, client nodes, client computers, client devices, computing devices, endpoints, or endpoint nodes. One or more of the clients 120a-120n may implement, for example, the first client device 130a, the second client device 130b, the third client device 130c, and/or the like. The remote machines 106a-106n may be generally referred to as servers or a server farm. In some example embodiments, a client 120 may have the capacity to function as both a client node seeking access to resources provided by a server 106 and as a server 106 providing access to hosted resources for other clients 120a-120n. The networks 104a and 104b may be generally referred to as a network 104. The network 104 including the networks 104a and 104b may be configured in any combination of wired and wireless networks.

The servers 106 may include any server type of servers including, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality. The servers 106 may include, for example, the web conference server 110 and/or the like.

A server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft internet protocol telephone; an application for streaming video and/or audio; an application for facilitating real-time-data communications; a hypertext transfer protocol (HTTP) client; a file transfer protocol (FTP) client; an Oscar client; a Telnet client; or any other set of executable instructions.

In some example embodiments, a server 106 may execute a remote presentation services program or other program that uses a thin-client or a remote-display protocol to capture display output generated by an application executing on a server 106 and transmit the application display output to a client 120.

In yet other example embodiments, a server 106 may execute a virtual machine, such as the first virtual machine 125a and/or the second virtual machine 125b, to provide, for example, to the user 150 at the client device 130, access to a computing environment such as the application 135. The virtual machine may be managed by, for example, a hypervisor (e.g., the first hypervisor 165a, the second hypervisor 165b, and/or the like), a virtual machine manager (VMM), or any other hardware virtualization technique within the server 106.

In some example embodiments, the network 104 may be a local-area network (LAN), a metropolitan area network (MAN), a wide area network (WAN), a primary public network, and/or a primary private network. Additional embodiments may include one or more mobile telephone networks that use various protocols to communicate among mobile devices. For short-range communications within a wireless local-area network (WLAN), the protocols may include 802.11, Bluetooth, and Near Field Communication (NFC).

FIG. 5B depicts a block diagram illustrating an example of a computing device 500, in accordance with some example embodiments. Referring to FIGS. 1-4 and 5A-B, the computing device 500 may be useful for practicing an embodiment of the migration controller 132 and the client device 130.

As shown in FIG. 5B, the computing device 500 may include one or more processors 248, volatile memory 270 (e.g., RAM), non-volatile memory 252 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 254, one or more communications interfaces 256, and a communication bus 258. The user interface 254 may include a graphical user interface (GUI) 260 (e.g., a touchscreen, a display, and/or the like) and one or more input/output (I/O) devices 262 (e.g., a mouse, a keyboard, and/or the like). The non-volatile memory 252 may store an operating system 264, one or more applications 266, and data 268 such that computer instructions of the operating system 264 and/or applications 266 are executed by the processor(s) 248 out of the volatile memory 270. Data may be entered using an input device of the GUI 260 or received from I/O device(s) 262. Various elements of the computing device 500 may communicate via communication the communication bus 258. The computing device 500 as shown in FIG. 5B is shown merely as an example, as the migration controller 132 and the client device 130 may be implemented by any computing or processing environment and with any type of machine or set of machines that may have suitable hardware and/or software capable of operating as described herein.

The processor(s) 248 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some example embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some example embodiments, the “processor” may be one or more physical processors or one or more “virtual” (e.g., remotely located or “cloud”) processors.

The communications interfaces 256 may include one or more interfaces to enable the computing device 500 to access a computer network such as a local area network (LAN), a wide area network (WAN), a public land mobile network (PLMN), and/or the Internet through a variety of wired and/or wireless or cellular connections.

As noted above, in some example embodiments, one or more computing devices 500 may execute an application on behalf of a user of a client computing device (e.g., the clients 120), may execute a virtual machine, which provides an execution session within which applications execute on behalf of a user or a client computing device (e.g., the clients 120), such as a hosted desktop session (e.g., associated with the application 135), may execute a terminal services session to provide a hosted desktop environment, or may provide access to a computing environment including one or more of: one or more applications, one or more desktop applications, and one or more desktop sessions in which one or more applications may execute.

FIG. 5C depicts a high-level architecture of an example of a virtualization system, in accordance with some example embodiments. As shown in FIG. 5C, the virtualization system may be a single-server or multi-server system, or a cloud system, including at least one virtualization server 301 configured to provide virtual desktops and/or virtual applications to one or more client access devices 120a-c. A desktop (or a virtual desktop) may refer to a graphical environment (e.g., a graphical user interface) or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per physical device) or virtual (e.g., many instances of an OS running on a single physical device). Each application may be executed on a local device, or executed on a remotely located device (e.g., remoted).

Virtualization server 301 may be configured as a virtualization server in a virtualization environment, for example, a single-server, multi-server, or cloud computing environment. Virtualization server 301 illustrated in FIG. 5C may be deployed as and/or implemented by one or more embodiments of server 106 illustrated in FIG. 5A or by other known computing devices. Included in virtualization server 301 is hardware layer 310 that may include one or more physical disks 304, one or more physical devices 306, one or more physical processors 308, and one or more physical memories 316. In some embodiments, firmware 312 may be stored within a memory element in physical memory 316 and be executed by one or more of physical processors 308. Virtualization server 301 may further include operating system 314 that may be stored in a memory element in physical memory 316 and executed by one or more of physical processors 308. Still further, hypervisor 302 may be stored in a memory element in physical memory 316 and be executed by one or more of physical processors 308. Presence of operating system 314 may be optional such as in a case where the hypervisor 302 is a Type A hypervisor.

Executing on one or more of physical processors 308 may be one or more virtual machines 332A-C (generally 332). Each virtual machine 332 may have virtual disk 326A-C and virtual processor 328A-C. In some embodiments, first virtual machine 332A may execute, using virtual processor 328A, control program 320 that includes tools stack 324. Control program 320 may be referred to as a control virtual machine, Domain 0, Dom0, or other virtual machine used for system administration and/or control. In some embodiments, one or more virtual machines 332B-C may execute, using virtual processor 328B-C, guest operating system 330A-B (generally 330).

Physical devices 306 may include, for example, a network interface card, a video card, an input device (e.g., a keyboard, a mouse, a scanner, etc.), an output device (e.g., a monitor, a display device, speakers, a printer, etc.), a storage device (e.g., an optical drive), a Universal Serial Bus (USB) connection, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in hardware layer 310 may include any type of memory. Physical memory 316 may store data, and in some embodiments may store one or more programs, or set of executable instructions. FIG. 5C illustrates an embodiment where firmware 312 is stored within physical memory 316 of virtualization server 301. Programs or executable instructions stored in physical memory 316 may be executed by the one or more processors 308 of virtualization server 301.

Virtualization server 301 may also include hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 may be any combination of executable instructions and hardware that monitors virtual machines 332 executing on a computing machine. Hypervisor 302 may be a Type 2 hypervisor, where the hypervisor executes within operating system 314 executing on virtualization server 301. Virtual machines may then execute at a layer above hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on virtualization server 301 by directly accessing the hardware and resources within hardware layer 310. That is, while Type 2 hypervisor 302 accesses system resources through host operating system 314, as shown, a Type 1 hypervisor may directly access all system resources without host operating system 314. A Type 1 hypervisor may execute directly on one or more physical processors 308 of virtualization server 301, and may include program data stored in physical memory 316.

Hypervisor 302, in some embodiments, may provide virtual resources to guest operating systems 330 or control programs 320 executing on virtual machines 332 in any manner that simulates operating systems 330 or control programs 320 having direct access to system resources. System resources can include, but are not limited to, physical devices 306, physical disks 304, physical processors 308, physical memory 316, and any other component included in hardware layer 310 of virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for virtual machine 332 executing on virtualization server 301. Examples of hypervisor 302 may include those manufactured by VMWare, Inc., of Palo Alto, Calif.; Xen Project® hypervisor, an open source product whose development is overseen by the open source XenProject.org community; Hyper-V®, Virtual Server®, and Virtual PC® hypervisors provided by Microsoft Corporation of Redmond, Wash.; or others. The virtualization server 301 may execute hypervisor 302 that creates a virtual machine platform on which guest operating systems 330 may execute. When this is the case, virtualization server 301 may be referred to as a host server. An example of such a virtualization server is Citrix Hypervisor® provided by Citrix Systems, Inc., of Fort Lauderdale, Fla.

Hypervisor 302 may create one or more virtual machines 332B-C (generally 332) in which guest operating systems 330 execute. In some embodiments, hypervisor 302 may load a virtual machine image to create virtual machine 332. The virtual machine image may refer to a collection of data, states, instructions, etc. that make up an instance of a virtual machine. In other embodiments, hypervisor 302 may execute guest operating system 330 within virtual machine 332. In still other embodiments, virtual machine 332 may execute guest operating system 330.

In addition to creating virtual machines 332, hypervisor 302 may control the execution of at least one virtual machine 332. The hypervisor 302 may present at least one virtual machine 332 with an abstraction of at least one hardware resource provided by virtualization server 301 (e.g., any hardware resource available within hardware layer 310). In some implementations, hypervisor 302 may control the manner in which virtual machines 332 access physical processors 308 available in virtualization server 301. Controlling access to physical processors 308 may include determining whether virtual machine 332 should have access to processor 308, and how physical processor capabilities are presented to virtual machine 332.

As shown in FIG. 5C, the virtualization server 301 may host or execute one or more virtual machines 332. Virtual machine 332 may be a set of executable instructions and/or user data that, when executed by processor 308, may imitate the operation of a physical computer such that virtual machine 332 can execute programs and processes much like a physical computing device. While FIG. 5C illustrates an embodiment where virtualization server 301 hosts three virtual machines 332, in other embodiments virtualization server 301 may host any number of virtual machines 332. Hypervisor 302 may provide each virtual machine 332 with a unique virtual view of the physical hardware, including memory 316, processor 308, and other system resources 304, 306 available to that virtual machine 332. The unique virtual view may be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to virtual machines 332.

Each virtual machine 332 may include virtual disk 326A-C (generally 326) and virtual processor 328A-C (generally 328.) Virtual disk 326 may be a virtualized view of one or more physical disks 304 of virtualization server 301, or a portion of one or more physical disks 304 of virtualization server 301. The virtualized view of physical disks 304 may be generated, provided, and managed by hypervisor 302. In some embodiments, hypervisor 302 may provide each virtual machine 332 with a unique view of physical disks 304. These particular virtual disk 326 (included in each virtual machine 332) may be unique, when compared with other virtual disks 326.

Virtual processor 328 may be a virtualized view of one or more physical processors 308 of virtualization server 301. The virtualized view of physical processors 308 may be generated, provided, and managed by hypervisor 302. Virtual processor 328 may have substantially all of the same characteristics of at least one physical processor 308. Virtual processor 308 may provide a modified view of physical processors 308 such that at least some of the characteristics of virtual processor 328 are different from the characteristics of the corresponding physical processor 308.

One or more aspects or features of the subject matter described herein can be realized in digital electronic circuitry, integrated circuitry, specially designed application-specific integrated circuit (ASIC), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

1. A system, comprising:
at least one data processor; and
at least one memory storing instructions, which when executed by the least one data processor, cause the at least one data processor to at least:
generate, at the first client device, a first recording of a web conference session between the first client device and a second client device, the first recording including a first content generated locally at the first client device and the second content generated remotely at the second client device, the first content including a first audio data and/or a first video data captured at the first client device, and the second content including a second audio data and/or a second video data captured at the second client device;
monitor, while generating the first recording at the web conference session, a quality of the second content the first client device receives from the second client device;
in response to the quality of the second content degrading below a threshold level, send, to the second client device, a first command to start a second recording of the second content generated locally at the second client device; and
send, to a repair engine, the first recording of the web conference session to enable the repair engine to generate a third recording of the web conference session in which portion of the first recording corresponding to the second content generated at the second client device is replaced and/or combined with the second recording of the second content generated at the second client device.

2. The system of claim 1, wherein the quality of the second content is monitored by at least morning a quality of a network connection between the first client device and the second client device.

3. The system of claim 2, wherein the quality of the network connection is monitored by at least measuring a latency, a jitter, and/or a packet loss.

4. The system of claim 1, wherein the quality of the second content is monitored by at least measuring a signal to noise ratio (SNR) and/or a bit error ratio (BER).

5. The system of claim 1, wherein the at least one data processor is further caused to at least:
in response to the quality of the second content received at the first client device improving above the threshold level, send, to the second client device, a second command to stop the second recording of the web conference session at the second client device.

6. The system of claim 5, wherein the first command and/or the second command is further sent in response to one or more user inputs received at the first client device.

7. The system of claim 1, wherein the at least one data processor is further caused to at least:
generate context data associated with the second recording of the web conference session; and
send, to the repair engine, the context data to enable the repair engine to generate, based at least on the context data, the third recording of the web conference session.

8. The system of claim 7, wherein the context data includes a starting timestamp and/or an ending timestamp of the second recording.

9. The system of claim 1, wherein the first portion of the first recording is replaced with the second portion of the second recording based at least on a first quality of the first portion of the first recording being below threshold and/or less than a second quality of the second portion of the second recording.

10. The system of claim 1, wherein the first content and the second content include an audio data and/or a video data.

11. A computer-implemented method, comprising:
generating, at the first client device, a first recording of a web conference session between the first client device and a second client device, the first recording including a first content generated locally at the first client device and the second content generated remotely at the second client device, the first content including a first audio data and/or a first video data captured at the first client device, and the second content including a second audio data and/or a second video data captured at the second client device;
monitoring, while generating the first recording at the web conference session, a quality of the second content the first client device receives from the second client device;
in response to the quality of the second content degrading below a threshold level, sending, to the second client device, a first command to start a second recording of the second content generated locally at the second client device; and
sending, to a repair engine, the first recording of the web conference session to enable the repair engine to generate a third recording of the web conference session in which a portion of the first recording corresponding to the second content generated at the second client device is replaced and/or combined with the second recording of the second content generated at the second client device.

12. The method of claim 11, wherein the quality of the second content is monitored by at least morning a quality of a network connection between the first client device and the second client device.

13. The method of claim 12, wherein the quality of the network connection is monitored by at least measuring a latency, a jitter, and/or a packet loss.

14. The method of claim 11, wherein the quality of the second content is monitored by at least measuring a signal to noise ratio (SNR) and/or a bit error ratio (BER).

15. The method of claim 11, further comprising:
in response to the quality of the second content the first client device receives from the second client device improving above the threshold level, sending, to the second client device, a second command to stop the second recording of the web conference session at the second client device.

16. The method of claim 15, wherein the first command and/or the second command is further sent in response to one or more user inputs received at the first client device.

17. The method of claim 11, further comprising:
generating context data associated with the second recording of the web conference session; and
sending, to the repair engine, the context data to enable the repair engine to generate, based at least on the context data, the third recording of the web conference session.

18. The method of claim 7, wherein the context data includes a starting timestamp and/or an ending timestamp of the second recording.

19. The method of claim 11, wherein the first portion of the first recording is replaced with the second portion of the second recording based at least on a first quality of the first portion of the first recording being below threshold and/or less than a second quality of the second portion of the second recording.

20. A non-transitory computer readable medium storing instructions, which when executed by at least one data processor, result in operations comprising:
generating, at the first client device, a first recording of a web conference session between the first client device and a second client device, the first recording including a first content generated locally at the first client device and the second content generated remotely at the second client device, the first content including a first audio data and/or a first video data captured at the first client device, and the second content including a second audio data and/or a second video data captured at the second client device;
monitoring, while generating the first recording at the web conference session, a quality of the second content the first client device receives from the second client device;
in response to the quality of the second content degrading below a threshold level, sending, to the second client device, a first command to start a second recording of the second content generated locally at the second client device; and
sending, to a repair engine, the first recording of the web conference session to enable the repair engine to generate a third recording of the web conference session in which a portion of the first recording corresponding to the second content generated at the second client device is replaced and/or combined with the second recording of the second content generated at the second client device.
